(19) United States
(12) Patent Application Publication
(10) Pub. No.: US 2026/0045241 A1
(43) Pub. Date: Feb. 12, 2026

(54) BRASS MUSICAL INSTRUMENT AND TRAINER

(71) Applicants: German Felipe Sanchez Solano, Lake Worth, FL (US); Adrian Fente, Boca Raton, FL (US)

(72) Inventors: German Felipe Sanchez Solano, Lake Worth, FL (US); Adrian Fente, Boca Raton, FL (US)

(21) Appl. No.: 19/289,751

(22) Filed: Aug. 4, 2025

Related U.S. Application Data
(60) Provisional application No. 63/679,901, filed on Aug. 6, 2024.

(51) Int. Cl. G10H 1/00; G10H 1/34; G10H 1/46

(52) U.S. Cl. CPC G10H 1/0008; G10H 1/34; G10H 1/46; G10H 2230/175

(57) ABSTRACT

An electrical audio generating apparatus and method to produce and/or emulate audio sound produced by a represented instrument, the apparatus includes: a housing containing audio sound generating circuitry having a microcontroller unit; multiple user-operated input key buttons extending from the housing to emulate valves of the represented instrument, the multiple input buttons moveable into multiple combinations of positions to provide fingerData input to the circuitry; and a variable input operator extending from the housing to emulate a level of embouchure and airflow, the variable input operator controllable by a user to provide a variable input into the circuitry, wherein the fingerData input and the variable input are received by the circuitry and processed by the microcontroller unit to produce audioData representing an audio sound corresponding to a note that is based upon the positioning of the multiple input key buttons and the variable input by the variable input operator.

### BACKGROUND

This disclosure relates to a device and method to simulate and/or emulate brass (e.g., wind) instruments and as a trainer for such instruments. The instrument and method utilizes manual interfaces operable by a user to vary and control the electrical audio processing and reproduction of sound to emulate one or more brass (wind) instruments, particularly suitable for practicing students and music enthusiasts learning how to play and train on brass (wind) instruments.

A problem faced by a student learning to play brass (wind) instruments is that the physical exertion of blowing into the brass (wind) instrument (e.g., a trumpet) while practicing is tiring and limits the amount of practice time that a student can undertake. There is a need for a training device instrument that will permit a player to practice longer without having to blow into the brass instrument for long periods of time, that will be compact, that is ergonomically easy to handle and use, and that does not have the mechanical complexity, maintenance, and expense of a true brass (wind) instrument. There is a need for an instrument and training device that will also permit a student learning to play the ability to practice the full extent of simulating and emulating the playing of the brass musical instrument. The proposed invention will address these needs by providing a compact, feature rich platform that provides and facilitates a student to learn how to play brass (wind) instruments, for example, the trumpet.

### SUMMARY OF THE INVENTION

The summary of the disclosure is given to aid the understanding of a brass musical instrument and trainer, and its method of operation preferably to emulate brass (wind) instruments for educational and practice purposes. The present disclosure is directed to a person of ordinary skill in the art. It should be understood that various aspects and features of the disclosure may advantageously be used separately in some instances, or in combination with other aspects and features of the disclosure in other instances.

An electrical audio generating apparatus to produce and/or emulate audio sound produced by a represented instrument is disclosed and described, the apparatus in one or more embodiments includes: a housing containing audio sound generating circuitry having a microcontroller unit; multiple user-operated key buttons extending from the housing to emulate valves of the represented instrument, the multiple input buttons moveable into multiple combinations of positions to provide fingerData input to the circuitry; and a variable user-operated input operator extending from the housing to emulate a level of embouchure and airflow provided by a user of the represented instrument, the variable input operator moveable to multiple positions each position representing a different embouchure level to provide a variable input into the circuitry, wherein the fingerData input and the variable input are received by the circuitry and processed by the microcontroller unit to produce audioData representing an audio sound corresponding to a note that is based upon the positioning of the multiple key buttons and the variable input operator.

In one or more configurations, the microcontroller, preferably an ESP32 module, uses a look-up table to select the audioData to produce based upon the fingerData and the variable input. In an aspect, the variable input operator is at least one of a variable input group consisting of; a rotary dial, a linear slider, and combinations thereof. Optionally, the variable input group is dented and has multiple selectable positions, where preferably the variable input group has eight (8) selectable positions. In a further arrangement, the multiple user-operated key buttons includes four key buttons, and in a further optional configuration at least one of multiple user-operated key buttons is a slidable ring. The circuitry according to a further embodiment includes at least one of a coder/decoder group consisting of: an audio codec, an audio digital to analog converter (DAC), and combinations thereof to convert a digital signal produced by the microcontroller to an analog sound signal. The circuitry in a further aspect further includes an amplifier to adjust the magnitude of the analog sound signal produced by the coder/decoder group. And the apparatus in an optional embodiment further includes at least one of a speaker to convert the analog sound signal produced and output by the amplifier to audio sound, an auxiliary output jack, and combinations thereof.

The apparatus according to one or more embodiments has a display and operator display control buttons for changing the display content and apparatus operation. The operator display control buttons in an arrangement includes at least one of a control group consisting of: a power button, an up button, a down button, an enter button, a cancel button, and combinations thereof. The apparatus optionally further includes a rest button/switch extending from the housing and operable by a user to provide at least one of a silence group consisting of: no audio sound from the apparatus, no output from the microcontroller, no audioData produced by the microcontroller, or combinations thereof. The rest button in an embodiment is configured on a different surface than the key buttons, and in an optional configuration is a three-way switch.

In one or more configurations, the microcontroller unit is mounted on a printed circuit board (PCB) that utilizes a Look-Up Table (LUT) to select the audioData to generate based on fingerData and a variable input. The fingerData in one or more embodiments comprises input signals from a linear slider and/or multiple upper key buttons. The variable input operator in one or more configurations comprises a rotary encoder includes 36 physical detents, internally mapped to eight (8) discrete positions ranging from 0 to 7 to provide the variable input. According to one or more arrangements, a configurable three-position (rest control) switch is assignable via the user interface, allowing any of its three positions to function as a temporary silence toggle (REST), off position (no REST), or a permanent silence toggle (HOLD). In one or more embodiments, activation of the rest button/switch does not suppress and/or alter fingerData; it only affects whether the instrument generates corresponding audioData.

The apparatus in one or more arrangements further includes a mouthpiece assembly having a mouthpiece for a user to blow into. The mouthpiece assembly in an arrangement further includes a pressure sensor that produces a variable pressure signal corresponding to the variable pressure by the user blowing into the mouthpiece, the mouthpiece assembly sending the variable pressure signal to the microcontroller as the variable input which alters the audioData produced by the microcontroller unit. The mouthpiece assembly in an aspect is integrated into a housing containing the multiple user-operated key buttons. The apparatus in an embodiment further includes an airflow toggle switch to select the variable input into the circuitry between the variable input produced by the variable input operator (e.g., rotary dial/encoder and/or linear slider) and the mouthpiece assembly. The apparatus can further include a power board supplying power to a main board containing the microcontroller, the power board comprising a voltage regulator, a battery manager, and a battery pack, preferably a rechargeable battery pack. The apparatus in one or more configurations can include a power input connector to supply the apparatus with power and/or recharge the rechargeable battery. At least one of a wireless connectivity group consisting of: Bluetooth, WiFi, and combinations thereof can optionally be included.

### BRIEF DESCRIPTION OF THE DRAWINGS

The various aspects, features, and embodiments of a brass musical instrument and trainer, and its method of operation will be better understood when read in conjunction with the figures provided. Embodiments are provided in the figures for the purpose of illustrating aspects, features, and various embodiments of the brass musical instrument and trainer, but the disclosure should not be limited to the precise arrangement, structures, assemblies, subassemblies, systems, circuitry, features, aspects, embodiments, methods, processes, devices, or uses shown, and the arrangement, structure, assembly, subassembly, system, circuitry, features, aspects, embodiments, methods, processes, and devices shown may be used singularly or in combination with other arrangements, structures, assemblies, subassemblies, systems, circuitry, features, aspects, embodiments, methods, processes, and/or devices.

FIG. 1 illustrates a top perspective view of a brass musical instrument and trainer according to an embodiment of the invention.

FIG. 2 illustrates a bottom perspective view of the brass musical instrument and trainer of FIG. 1.

FIG. 3 illustrates a front view of the brass musical instrument and trainer of FIG. 1.

FIG. 4 illustrates a left-side view of the brass musical instrument and trainer of FIG. 1.

FIG. 5 illustrates a right-side view of the brass musical instrument and trainer of FIG. 1.

FIG. 6 illustrates a top view of the brass musical instrument and trainer of FIG. 1.

FIG. 7 illustrates a bottom view of the brass musical instrument and trainer of FIG. 1.

FIG. 8 illustrates an embodiment of an optional mouthpiece for the brass musical instrument and trainer.

FIG. 9 illustrates a schematic block diagram of an embodiment of the electrical circuitry of a brass (wind) musical instrument and trainer for producing sound that is capable of emulating multiple brass (wind) musical instruments according to an embodiment of the invention.

FIG. 10 illustrates a top perspective view of a brass musical instrument and trainer according to another embodiment of the invention.

FIG. 11 illustrates a bottom perspective view of the brass musical instrument and trainer of FIG. 10.

FIG. 12 illustrates a front view of the brass musical instrument and trainer of FIG. 10.

FIG. 13 illustrates a left-side view of the brass musical instrument and trainer of FIG. 10.

FIG. 14 illustrates a right-side view of the brass musical instrument and trainer of FIG. 10.

FIG. 15 illustrates a top view of the brass musical instrument and trainer of FIG. 10.

FIG. 16 illustrates a bottom view of the brass musical instrument and trainer of FIG. 10.

FIG. 17 illustrates a schematic block diagram of the another embodiment of the electrical circuitry of a brass (wind) musical instrument and trainer for producing sound that is capable of emulating multiple brass (wind) musical instruments according to an embodiment of the invention.

FIG. 18 illustrates a top left perspective view of a brass musical instrument and trainer according to a further embodiment of the invention.

FIG. 19 illustrates a bottom right perspective view of the brass musical instrument and trainer of FIG. 18.

FIG. 20 illustrates a bottom view of a printed circuit board (PCB) implemented in the brass musical instrument and trainer of FIG. 18.

FIG. 21 illustrates a top view of the PCB of FIG. 20.

### DETAILED DESCRIPTION

The following description is made for illustrating the general principles of the invention and is not meant to limit the inventive concepts claimed herein. In the following detailed description, numerous details are set forth in order to provide an understanding of a brass (wind) musical instrument and trainer, to emulate one or more brass (wind) instruments, and methods of operation, however, it will be understood by those skilled in the art that different and numerous embodiments of the brass (wind) musical instrument and trainer, methods of operation, and their uses may be practiced without those specific details, and the claims and invention should not be limited to the arrangements, structures, embodiments, assemblies, subassemblies, mechanisms, structures, features, functional units, circuitry, processes, methods, aspects, features, or details specifically described and shown herein. Further, particular features, mechanisms, assemblies, subassemblies, structures, aspects, functions, circuitry, embodiments, and details described herein can be used in combination with other described features, mechanisms, assemblies, subassemblies, structures, aspects, functions, circuitry, embodiments, and/or details in each of the various possible combinations and permutations.

Unless otherwise specifically defined herein, all terms are to be given their broadest possible interpretation including meanings implied from the specification as well as meanings understood by those skilled in the art and/or as defined in dictionaries, treatises, etc. It should also be noted that, as used in the specification and the appended claims, the singular forms “a,” “an”, “first”, “second” and “the” include, and do not preclude, a plurality, unless otherwise specified. In the claims, the term “comprises/comprising” does not exclude the presence of other elements, features, or steps.

Furthermore, although individually listed, a plurality of means, elements, or method steps may be implemented by, e.g., a single unit, element, or piece. Additionally, although individual features may be included in different claims, these may advantageously be combined, and their inclusion individually in different claims does not imply that a combination of features is not feasible and/or advantageous. Reference signs or characters in the disclosure and/or claims are provided merely as a clarifying example and shall not be construed as limiting the scope of the claims in any way.

This disclosure is directed to versatile and compact electrical audio processing and generating solutions for instrument emulation, for example brass (wind) instrument emulation, that combines microcontroller functionality with advanced audio processing capabilities and interactable interfaces. The disclosure includes specialized circuitry designed specifically for electrical audio processing and generation, aimed, for example, at emulating brass (wind) musical instruments for educational and practice purposes. More specifically, the disclosure relates to audio processing that in an approach includes audio processing circuitry equipped with a microcontroller capable of handling multiple audio input and output channels and/or interfaces, audio codecs, and interactive interfaces. The circuitry in one or more embodiments includes wireless connectivity, and in one or more configurations integrates and combines Wi-Fi and/or Bluetooth functionalities with powerful processing capabilities to provide a comprehensive solution for audio recording and playback with at least reasonable fidelity, suitable for practicing students and music enthusiasts learning how to play instruments, for example brass (wind) instruments. The disclosure is focused on the trumpet as an example brass instrument and contemplates implementation for other brass instruments. Example brass instruments can include the Trumpet, Trombone, Tuba, French Horn, Cornet, Euphonium, Flugelhorn, Mellophone, etc. Other non-brass instruments are contemplated.

The proposed brass (wind) musical instrument and trainer will include a microprocessor that in one or more embodiments includes Wi-Fi and Bluetooth and can in one or more arrangements include a variety of audio input options, (e.g., audio input jack(s), wireless input connectivity) and a variety of output options (e.g., output jack(s), internal speakers, wireless output connectivity). For example, the brass musical instrument and trainer can have a headphone jack and/or line out jacks for external speakers.

The brass (wind) musical instrument and trainer will include one or more manual, human interactable, interfaces for purposes of emulating valves and/or the mouthpieces of the one of more brass (wind) musical instruments. In one or more arrangements, the brass (wind) musical instrument and trainer will also have control panel interfaces for configuring and operating the instrument/trainer. In one or more embodiments, the brass (wind) musical instrument and trainer will include multiple (e.g., three to four) manually operated keys and/or buttons (also referred to as key buttons) to emulate valves, at least one variable user-operated input operator to emulate a mouthpiece of a brass (wind) instrument, and an optional display, and a control interface to configure and display, for example, volume, instrument selection, powerup, battery charge status, etc. In one or more embodiments the at least one variable user-operated input operator includes a rotary disc and/or linear slider to emulate the mouthpiece, and/or an optional mouthpiece assembly to emulate a mouthpiece of a brass (wind) instrument that includes a breath (pressure) sensor to measure the blowing pressure of a user.

The brass (wind) musical instrument and trainer in one or more configurations will support various audio processing functions including optionally one or more of the following: audio streaming over Wi-Fi or Bluetooth, audio playback and recording, and real-time audio processing (reproducing brass (wind) instrument sounds). The brass (wind) musical instrument and trainer preferably will be powered by a battery management system (e.g., a LiPo battery management system) using power ports (e.g., USB ports) that provide flexibility in power sources, including USB power adapters. The battery can be rechargeable or otherwise and a port can be provided to recharge the battery, or an easily accessible compartment can be provided to easily replace the battery. The on-board power management system preferably permits portability and provides stable operation across various input voltages. The versatile nature of the proposed brass (wind) musical instrument and trainer will be suitable for a wide range of applications including in one or more configurations emulating brass (wind) musical instruments, providing wireless audio streaming and recording systems, and educational tools for learning how to play brass (wind) instruments.

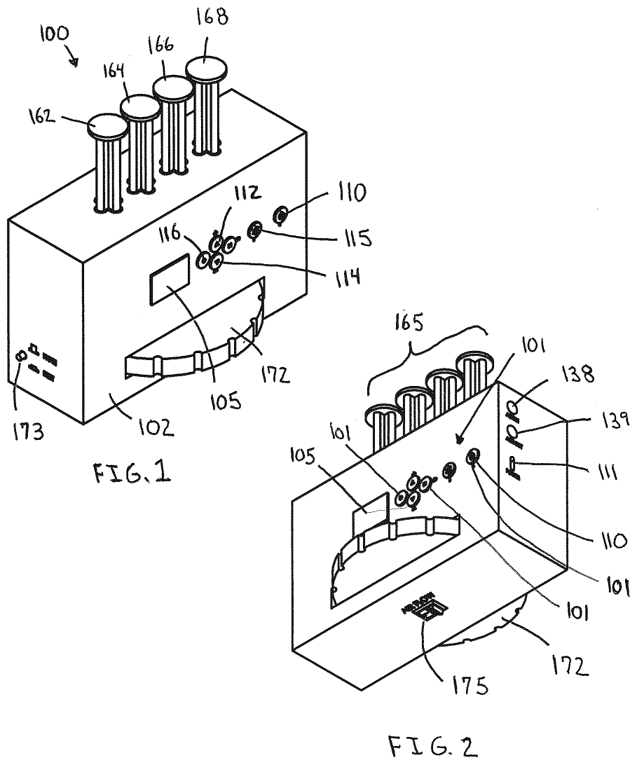

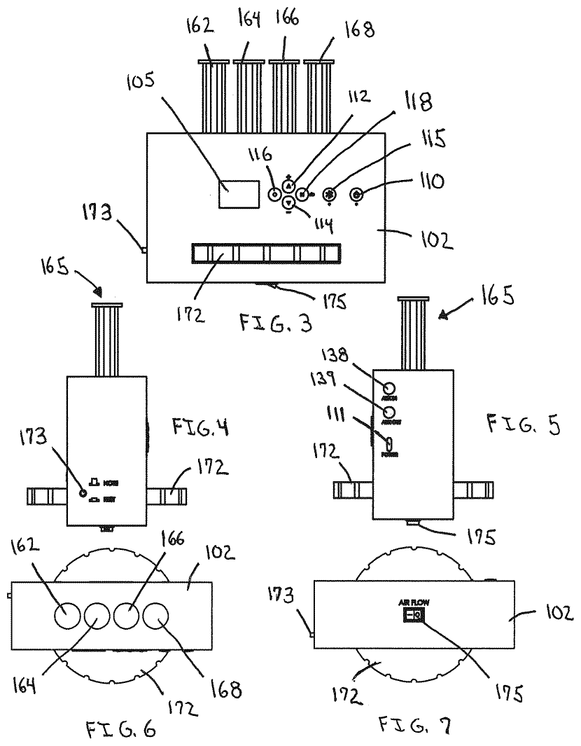

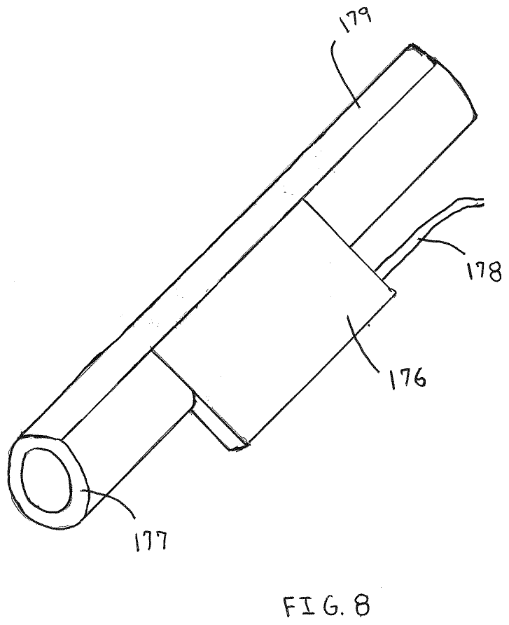

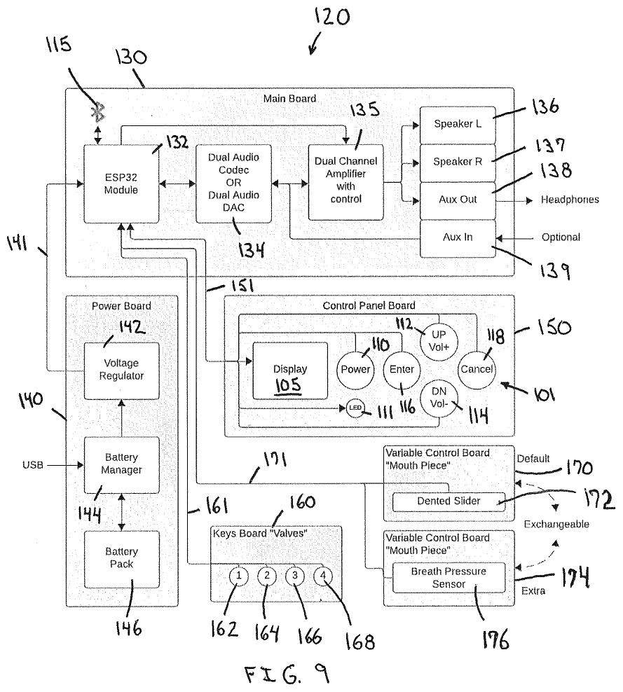

FIGS. 1-8 illustrate the brass (wind) musical instrument and trainer 100 (also referred to as “instrument/trainer” or “instrument trainer”) according to an embodiment. The instrument/trainer 100 includes a housing 102 having a display 105 and multiple input buttons 101 for configuring and operating instrument/trainer 100. In the embodiment of FIGS. 1-7, buttons 101 on instrument/trainer includes power button 110 for turning the instrument/trainer 100 on or off and managing the power state of the system. Buttons 101 further include Bluetooth button 115 which toggles the Bluetooth connectivity on or off, enabling or disabling wireless audio streaming. Buttons 101 further include up button 112 used to navigate upwards through the menu options and also to increase the volume of the audio output and the down button 114 to navigate downwards through the menu options and also to decrease the volume of the audio output. The instrument/trainer 100 further includes an enter button 116 used to select and approve menu options and act as a confirmation key on for the interface and a cancel (return) button 118 that allows the user to cancel an action or navigate back to the previous menu screen.

Display 105, preferably an OLED display, provides various information based upon a user's interactions and the current state of the device and the menu. Display elements include menu navigation, battery levels, volume level, note display, audio output, configuration settings to control the behavior of buttons, help tips and/or brand information. The menu navigation display will show the current menu options available, highlighting the current option as the user navigates using the up button 112 and down button 114. The enter button 116 confirms the currently highlighted option, leading to either a sub-menu or executing a command. The cancel (or return) button 118 allows the user to return to the main menu or earlier sub-menu. The battery level display indicates the current battery level, providing real-time updates on the remaining power. The battery level display permits the user to be aware of the device's power status so that a user can take action to recharge the battery if necessary.

The current volume level is displayed and is adjustable by the user to increase or decrease the volume by using the up button 112 or the down button 114, which permits precise control over the audio output. The display 105 can also optionally show the current note being played, providing the user feedback and information about the audio output of the instrument/trainer 100. The display 105 can also optionally show where the audio output is being played, e.g., via Bluetooth, via audio jack, via headphone, or the device's speaker(s).

When the instrument/trainer 100 is turned on using the power button 110, the display 105 is initialized and the monitoring of the state of the buttons 101 is started. Throughout all operations the state of each button 101 is monitored and the display 105 is updated accordingly. After initiation, the main screen appears on the display 105 showing relevant information such as audio output, battery levels, and others mentioned above. Pressing the enter button 116 from the main screen opens the main menu for adjusting the volume, enabling Bluetooth, viewing battery status, changing the selected instrument, and accessing other settings.

The various menus are controlled and operated by pressing the up button 112 and the down button 114 to scroll through the menu options and the display 105 updates to reflect and highlight the current option and the enter button 116 selects the highlighted option, and the cancel button 118 returns to the previous menu. In the main menu screen pressing the up button 112 increases the volume while pressing the down button 114 decreases the volume, and the display 105 illustrates the current volume level in real time. Pressing the Bluetooth button 115 toggles the Bluetooth state. The display 105 can be configured to show a Bluetooth icon (or other icon) or status message indicating whether or not Bluetooth is enabled. Additionally, or alternatively an LED can be provided to show Bluetooth operation and state. The power button 110 turns the device on and off. If the instrument/trainer 100 is turned off, the display 105 is shut down and all operations cease to save power. When turned back on, the instrument/trainer 100 resumes from the main menu.

Within housing 102 of instrument/trainer 100 is circuitry 120 for generating and producing audio signals that can be converted into sound. FIG. 9 illustrates a schematic block diagram of an embodiment of circuitry 120 that includes a main board 130, a power board 140, a control panel board 150, keys board 160, and mouthpiece variable control boards 170, 174. Main board 130 receives power 141 (e.g., 5V DC) from power board 140 and input 161 from keys board 160 and input 171 from mouthpiece variable control boards 170, 174. Main board 130 includes a microprocessor and/or microcontroller unit (MCU) 132, an audio codec or DAC (mono or dual) 134, an amplifier 135, optional speaker (optional left speaker 136 and/or optional right speaker 137), an auxiliary output jack 138, to receive for example headphones, and an optional auxiliary input jack 139 to receive audio input. It can be appreciated that circuitry 120 may be arranged differently and can be included on more or less printed circuit boards (PCBs) other than main board 130, power board 140, control panel board 150, keys board 160, and variable control boards 170, 174.

The microcontroller unit (MCU) 132 can include a dual core processor, Wi-Fi, and Bluetooth. In one or more embodiments the MCU 132 is an ESP32 module The ESP32 module has a combination of 36 pins that vary from input only to input-output. All pins on ESP32 module are digital by default, but 18 of them can be programmed as analog. I2C is a digital input-output comms protocol available on the ESP32 module. In the instrument/trainer 100, with the exception of the input 171 from the variable control board 170, 174, all pins connected to the ESP32 are digital. The input 161 from the keys board 160 are binary.

The keys board 160 includes four push buttons 162, 164, 166 168, also referred to as keys or key buttons (collectively buttons, keys, or key buttons 165), which represent the valves of the brass instrument, each connected to a digital input of the MCU 132 such that when any one of the keys are pressed, the MCU 132 can read its state (1: pressed, 0: not pressed). The key buttons or pushbuttons 165 can be simple buttons or can be slidable to emulate the operation of valves of the brass (wind instrument). Preferably the keys buttons 165 extend from the housing 102 in a manner to simulate the configuration and spacing as they might appear on a brass (wind) instrument, e.g., configured, arranged, and spaced as the valves on a trumpet or other brass wind instrument. The key buttons 165 are manually operated by a user to generate and produce audio sound from instrument/trainer 100. While only one input 161 is shown from the keys board 160 it can be appreciated that there can be four separate inputs into MCU 132 from keys board 160, one for each of key buttons 162, 164, 166, and 168 connected to a separate pin input on the MCU 132.

The variable control board 170 includes one or more variable user operated input operators extending from the housing 102 to emulate a level of embouchure and airflow provided by a user of the represented instrument. In an embodiment the variable user operated input operator is an analog dented rotary dial 172 on mouthpiece variable control board 170 that is rotatable by a user to simulate and emulate the pressure produced by a user when blowing into a brass (wind) instrument. There are multiple angular positions of the rotary dial 172 that can be detected to determine the position of the rotary dial 172. The user variable positions of the rotary dial 172 represent a level of embouchure and airflow. In an embodiment, the rotary dial has sixteen (16) dents but only eight (8) are selective and each selectable dent represents a level of embouchure and airflow. It can be appreciated that rotary dial 172 can have more or less dents and more or less of the dents can be selectable to create a different level of embouchure and airflow. The output 171 of the rotary dial 172 is connected to one of the analog pins of the MCU 132 so that the MCU 132 can detect the position of the dial and hence the level of embouchure and airflow.

By turning or rotating rotary dial 172 a user adjusts the level of embouchure and airflow. Rotary dial 172 in an embodiment can extend from housing 102 on both sides so that it can be manipulated and rotated on either side of the instrument/trainer 100 so that the instrument/trainer 100 can be operated by the left or right hand of a user, for example, to account for right-handed and left-handed performers. It can be appreciated that instead of a rotary dial 172 that the variable user-operated input operator can be provided by a linear slider, for example a dented slider, that provides variable input and control by the user. The instrument/trainer 100 also has a push button 173 called rest which extends from the housing 102 operable by a user for purposes of creating a rest as will be described below in connection with the operation and playing of instrument/trainer 100.

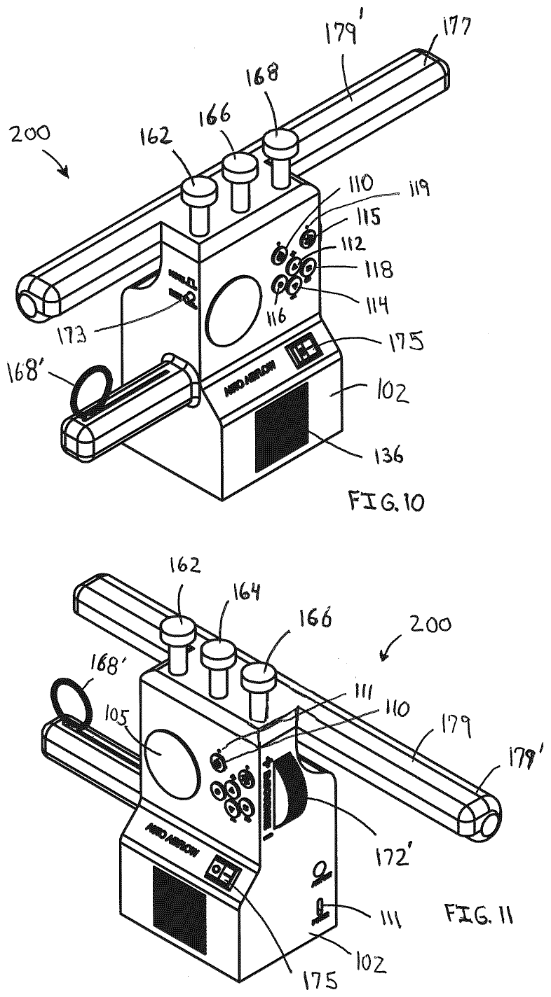

Alternatively, or additionally, an embodiment of the variable user-operated input operator can be an optional mouthpiece assembly 179 shown in FIG. 8. Mouthpiece assembly 179 can include an optional mouthpiece accessory circuitry 174 that includes a barometer sensor 176 to detect air pressure delivered by a user by blowing into a mouthpiece 177. The barometer sensor 176 is inside tubing and is configured to measure airflow and pressure as users blow into mouthpiece 177 to produce a note as in a regular brass (wind) instrument. The barometer sensor 176 is connected to the MCU 132 via I2C to detect the air pressure. The instrument/trainer 100 in an optional embodiment where the mouthpiece assembly 179 is included can also have a toggle switch 175 mounted on the housing 102 that is operable by a user called auto airflow that is connected via digital pin to MCU 132. The toggle switch 175 permits operation between the variable input rotary dial (or slider) 172 and the mouthpiece assembly 179.

The MCU 132 includes an I2C pin connected to control panel board 150 to provide output to display 105 and for users to interact with the configuration menus by interacting with and interfacing with buttons 101, e.g., power button 110, enter button 116, up button 112, down button 114, and cancel button 118, connected to control panel board 150. Bluetooth button 115 can be connected and arranged on Control Panel board 150 and/or on main board 130. In addition, one or more LEDs 119 can be connected via digital pin to MCU 132 to show Bluetooth connectivity and one or more LEDs 11 can show power on or off. The main board 130 including MCU 132 is powered by power board 140 that includes voltage regulator 142, battery manager 144 and battery pack 146. The power board or battery module 140 regulates the voltage and manages the battery pack 146.

The Main Board 130 has an Audio Digital to Analog (DAC) 134 (e.g., a Mono DAC) connected to the MCU 132 via digital pin. The (Mono) Audio Digital to Analog (DAC) 134 receives digital signals from the MCU 132 that represent sounds and converts the digital signals to analog signals that a speaker (e.g. speakers 136, 137) can play. The DAC 134 is connected to an Audio Amplifier (AMP) 135 (e.g. a Mono AMP) that is controlled by the MCU 132 via I2C. The AMP 135 receives the analog signals from DAC 134 and amplifies them according to the level established by the MCU 132 (which is controlled by volume buttons 112, 114 making the audio signals louder or softer). The AMP 135 then sends the amplified signals to a speaker (e.g., 136, 137) which will output them as sounds. Alternatively, there is an auxiliary output jack 138 for wired headphones that, when connected, disables the speaker and plays on the headphones. Alternatively, the auxiliary output jack 138 can be for external speakers, in which case the internal speakers 136, 137 may or may not be disabled.

The device's software is divided into 2 main modules: note playing and interface control. For note playing the MCU 132 is programmed to store a number of waveforms that play specific notes from any listed instrument (trumpet, tuba, horn, etc.). For example, a 440 Hz sinusoidal waveform represents the note A4 played by a trumpet. The MCU 132 also has a list of key combinations plus embouchure levels that a listed instrument needs pressed to produce any specific note. For instance, on a trumpet, pressing the valves (keys) 162 and 166 at an embouchure of level 3 to produce an A4 note. These waveforms, referred to as audioData, and key combinations plus embouchure, referred to as fingerData, are referenced on a Look-up Table (LUT) that corresponds one to the other. When the user presses a specific set of keys 165 at a specific embouchure (as determined by rotary dial 172 or air pressure from mouthpiece assembly 179), the MCU 132 finds the matching fingerData on the LUT and sends the corresponding audioData as a digital signal to the DAC 134.

To determine the embouchure, the MCU 132 reads information from the variable control board 170 as follows. If Rotary Dial 172 is used and if the user has pressed the Auto Airflow switch 175 on, the MCU 132 will automatically and constantly read the rotary dial 172. That is, in an example the airflow toggle switch 175 indicates whether MCU 132 should read data from the rotary dial 172 or from optional mouthpiece assembly 179. The current position of the rotary dial 172 determines the level of embouchure. There are 8 embouchure levels according to the example embodiment. The user rotates the rotary dial 172 to the position needed and presses the key combinations (e.g., buttons 162, 164, 166, 168) for the desired note. The MCU 132 reads this fingerData, finds it on the LUT and sends the corresponding audioData to the DAC 134.

If optional mouthpiece assembly 179 (e.g., pressure sensor 176) is used and if the user has pressed the Auto Airflow switch off 175, the MCU 132 will automatically read the output 178 from barometer sensor 176. The user blows into the mouthpiece 177 and presses the necessary keys (e.g., 162, 164, 166, 168) to produce a desired note. When the user starts to blow into the mouthpiece 177, the pressure on the barometer sensor 176 will change. The MCU 132 will compare the measured pressure as provided as output 178 from variable control board 174 to the values on the LUT along with the rest of the fingerData, and then it will send the corresponding audioData to the DAC 134.

Table 1 below represents an example of LUT table showing the fingerData, the embouchure level (by operation of the rotary dial 172) and/or the pressure as measured by the pressure sensor 174 from optional mouthpiece 179 and the resulting audioData. It can be appreciated that the LUT Table 1 does not show all the notes but only a sampling of the notes and resulting audioData.

TABLE 1

| | fingerData (Key 1, Key 2, | | | | | Pressure |
|---|---|---|---|---|---|---|
| audioData | Key 3, Key 4) | | | | Embouchure | (kPa) |
| B3.wav | 0 | 0 | 0 | 1 | 1 | 2.1-2.4 |
| C4.wav | 0 | 0 | 0 | 0 | 1 | 2.1-2.4 |
| Db4.wav | 0 | 1 | 1 | 1 | 2 | 3.4-3.7 |
| D4.wav | 0 | 1 | 1 | 0 | 2 | 3.4-3.7 |

To play the instrument/trainer 100, a user turns the instrument/trainer 100 on using power button 110, selects the desired instrument (e.g., trumpet, tuba, trombone, French horn, etc.) from the menu on the display 105 using interface buttons 112, 114, 116 and 118, optionally connects to Bluetooth speaker using Bluetooth button 115. If the user is going to use rotary dial 172, the user presses the Auto Airflow switch 175 on. The device's speaker(s) (e.g., 136, 137) plays a constant note correspondent to the current position of the rotary dial 172 and positioning of the keys 165. The user proceeds to press and manipulate the “valves” (e.g., 162, 164, 166, 168) to produce the next note. The device's speaker (e.g., 136, 137) produces a new sound immediately and constantly matching the note currently played by the user according to the position of the keys (e.g., 162, 164, 166, and 168) and the rotary dial 172. To create a temporary silence (rest), the user can press the Rest button 173 to stop the auto airflow momentarily, effectively producing a silence as long as the Rest button 173 is pressed. Once practice is done, the user presses the Auto Airflow button Off 175 and then the power button 110 to turn off the instrument/trainer 100.

If optional mouthpiece assembly 179 with pressure sensor 176 is used, a user confirms the auto airflow switch 175 is off. The user blows into the mouthpiece 177 of the mouthpiece assembly 179 similar to a note on a regular instrument. The device's speaker (e.g., 136, 137) plays a constant note matching the note the user is blowing into the mouthpiece 177 based upon the positioning of the keys 165. The user proceeds to press and manipulate the key buttons (e.g., 162, 164, 166, 168), which emulate the valves of a regular trumpet, to produce the next note. The device's speaker (e.g., 137, 138) produces a sound that is constant with no silences (rests) for as long as the user keeps on blowing through the mouthpiece 177. To produce silence, the user can stop blowing. Once practice is done, the user presses the power button 110 to turn off the instrument/trainer 100.

In an embodiment of music instrument and trainer 100, the housing 102 is 45-60 mm (preferably about 50 mm thick); 80-125 mm high (preferably about 95 mm high); and has a length of about 140-160 mm (preferably about 150 mm), although other dimensions are possible and contemplated for the housing 102. The instrument and trainer 100 has four keys 165 although it can be appreciated that a different number of keys (more or less) is possible. The keys 165 in an embodiment are configured to be moved and/or slide between about 0-24 mm to emulate the movement of valves in brass wind instruments, although other dimensions are possible and contemplated. The rotary dial 172 in an example has a diameter of 80-100 mm and a thickness of approximately 10 mm, although other dimensions are possible and contemplated.

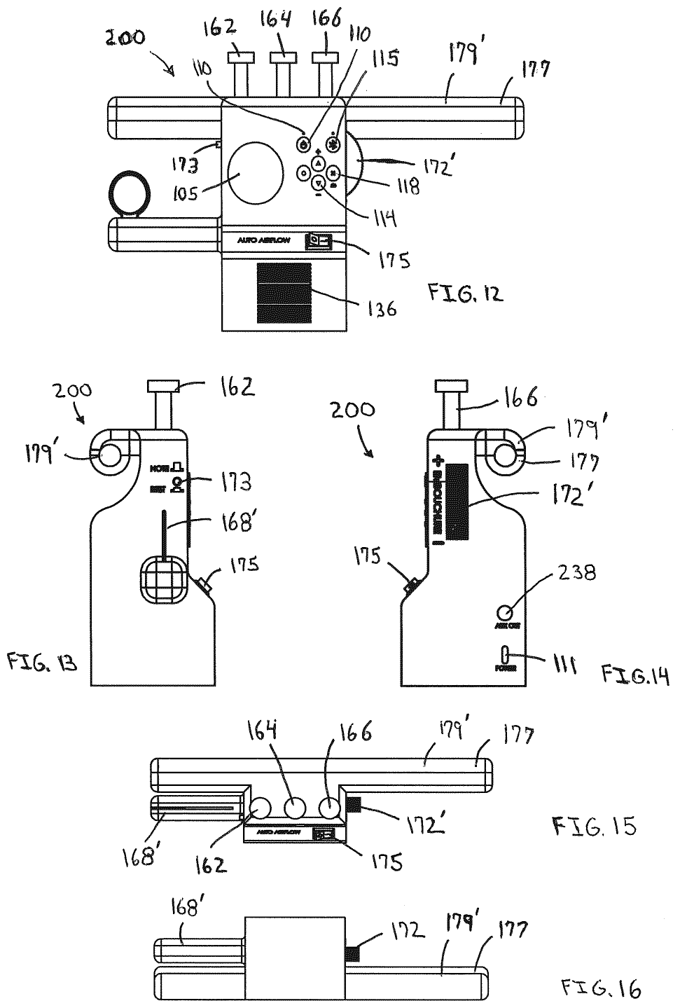

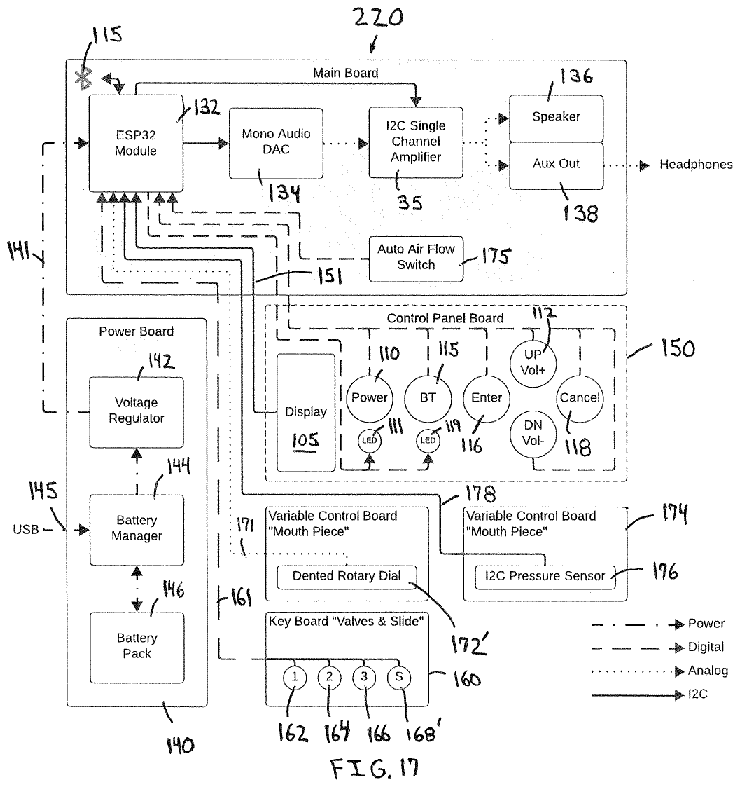

FIGS. 10-16 illustrate the brass (wind) musical instrument and trainer 200 (also referred to as “instrument”, “trainer” and/or “instrument/trainer”) according to another embodiment. The instrument/trainer 200 includes a housing 102 having a display 105 and multiple input buttons 101 for configuring and operating instrument/trainer 200. The features and components of the embodiment of FIGS. 10-16 are similar to the embodiment of FIGS. 1-8, and the same numbers represent the same or substantially similar feature. Description of features and components of the embodiment of FIGS. 10-16 that are the same or a substantially the same as the embodiment of FIGS. 1-8 will not be repeated. For example, buttons 101 to control operation of instrument trainer 100 are substantially the same as instrument trainer 200. Instead, the different features, functionality, components, and/or subsystems of instrument trainer 200 as compared to instrument trainer 100 will be the focus of the description of instrument trainer 200.

Instrument trainer 200 includes an integrated mouthpiece 179′ having a mouthpiece 177 and a pressure sensor 176 (not shown in FIGS. 10-16). A user would blow into mouthpiece 177 as described in connection with optional mouthpiece assembly 179 of FIGS. 1-9. The variable control board 174 and/or pressure sensor 176 of optional mouthpiece 169′ sends signal 178 to main board 130, preferably MCU 132 preferably via I2C input-output comms protocol. The housing for integrated mouthpiece assembly 179′ is substantially cylindrical with a diameter of approximately 22-24 mm that extends approximately 100 mm from main body of housing 102 in a first direction and extends about 65 mm from main body of housing 102 in a second direction. The positioning and configuration of integrated mouthpiece assembly 179′ can have a layout, configuration, arrangement, and/or association with housing 102 preferably in a manner to simulate and/or emulate as specific brass (wind) instrument. Other arrangements and configurations for the positioning and configuration of integrated mouthpiece assembly 169′ are contemplated.

In addition, instrument trainer 200 includes three key buttons 165 as first key button 162, second key button 164 and third key button 166 instead of four key buttons 165 as in the embodiment of instrument trainer 100. Key buttons 162, 164 and 166 in instrument trainer 200 operate as described in instrument trainer 100. In addition, instrument trainer 200 has a ring slider variable input operator 168′ (also referred to as “ring slider”, slider operator”, and/or “slider ring (fourth) key”), where ring slider 168′ operates to provide input into the main board 130 (e.g., MCU 132) as described in connection with key button 168 of instrument trainer 100, including how key button 168 provides input into main board 130 (e.g., MCU 132). As illustrated in FIGS. 10-16 ring slider 168′ is integrally connected with housing 102 of instrument trainer 200 and provides input by applying a force to ring slider 168′ in a different direction than key button 168 of instrument trainer 100. Ring slider 168′ moves linearly, similarly to key buttons 162, 164, and 166, but in a different direction with respect to the housing 102 than key buttons 162, 164, and 166. The positioning of key buttons 162, 164, 166, and ring slider 168′ can have a layout, configuration, arrangement, and/or association with housing 102 preferably in a manner to simulate and/or emulate as specific brass (wind) instrument. Other arrangements and configurations for the positioning and configuration of key buttons 162, 164, 166, and ring slider 168′ are contemplated.

Instrument trainer 200 includes rotary dial 172′ that is similar to and operates in the same manner as rotary dial 172 in instrument trainer 100. Rotary dial 172′ in instrument trainer 200, as illustrated in FIGS. 10-16, is sized and positioned differently than rotary dial 172 in instrument trainer 100 and rotates about an axis that is positioned differently with respect to housing 102 than the rotational axis of rotary dial 172 of instrument trainer 100. Rotary dial 172′ extends from only one side of housing 102 for operation and contact by a user.

Within housing 102 of instrument/trainer 200 is circuitry 220 for generating and producing audio signals that can be converted into sound. FIG. 17 illustrates a schematic block diagram of an embodiment of circuitry 220 that includes a main board 130, a power board 140, a control panel board 150, keys board 160, and mouthpiece variable control boards 170, 174. Main board 130 receives power 141 (e.g., 5V DC) from power board 140 and input 161 from keys board 160 and input 171 from mouthpiece variable control boards 170, 174. Main board 130 includes a microprocessor and/or microcontroller unit (MCU) 132, a mono audio codec or DAC 134, an amplifier 135, optional speaker 136, and an auxiliary output jack 138, to receive for example headphones. It can be appreciated that circuitry 220 may be arranged differently and can be included on more or less printed circuit boards (PCBs) other than main board 130, power board 140, control panel board 150, keys board 160, and variable control boards 170, 174.

Circuitry 220 operates substantially similar to circuitry 120 in instrument/trainer 100. In this manner main board 130 in circuitry 200 operates the same as or substantially the same as main board 130 in circuitry 100. The main difference between main board 130 in circuitry 220 is the additional input to MCU 132 from auto air flow switch 175 on main board 130 and additional inputs to MCU 132 from control panel board 150 and separate inputs 171, 178 from mouthpiece variable control boards 172 and 174. As discussed above, ring slider 168′ in instrument trainer 200 provides input similar to key 168 in instrument trainer 100, where circuitry 220 shows the input from ring slider 168′ on keys board 160, where output 161 from keys board 160 is sent to MCU 132 on main board 130.

Table 2 below represents an example of LUT table showing the fingerData (using three keys 162, 164, 165 and slider ring 168′ of instrument/trainer 200), the embouchure level (by operation of the rotary dial 172′) and/or the pressure as measured by the pressure sensor 176 from integrated mouthpiece assembly 179′ and the resulting audioData. It can be appreciated that the LUT Table 2 does not show all the notes but only a sampling of the notes and resulting audioData.

TABLE 2

| | fingerData (Slide, Key 1, | | | | | Pressure |
|---|---|---|---|---|---|---|
| audioData | Key 2, Key 3) | | | | Embouchure | (kPa) |
| B3.wav | 0 | 0 | 0 | 1 | 1 | 2.1-2.4 |
| C4.wav | 0 | 0 | 0 | 0 | 1 | 2.1-2.4 |
| Db4.wav | 0 | 1 | 1 | 1 | 2 | 3.4-3.7 |
| D4.wav | 0 | 1 | 1 | 0 | 2 | 3.4-3.7 |

In an embodiment of music instrument and trainer 100, the housing 102 is 50-70 mm (preferably about 60 mm thick); 115-135 mm high (preferably about 125 mm high); and has a length of about 240-250 mm (preferably about 245 mm), although other dimensions are possible and contemplated for the housing 102. The instrument and trainer 100 has three key buttons 165 (key buttons 162, 164, 166) and slider ring 168, although it can be appreciated that a different number of keys (more or less) and slider rings (more or less) is possible. The key buttons 165 in an embodiment are configured to be moved and/or slide between about 0-24 mm while slider ring 168 is configured to slide between about 0-65 mm, and preferably configured to emulate the movement of valves in brass wind instruments, while although other dimensions are possible and contemplated. The rotary dial 172 in an example has a diameter of 15-25 mm (preferably 20 mm) and a thickness of approximately 10 mm, although other dimensions are possible and contemplated.

It can be appreciated that optional mouthpiece assembly 169, integrated mouthpiece 169′, rotary dial 172, rotary dial 172′ can have a different layout, configuration, arrangement, and/or association with housing 102 than illustrated in instrument trainer 100, 200. In addition, key buttons 165, including first key button 162, second key button 164, third key button 166 and fourth key button 168, of instrument 100, and key buttons 165, including first key button 162, second key button 164, third key button 166 and slider ring 168, of instrument 200 can be configured, arranged, laid out and/or associated with housing 102 as shown or can have a different layout, configuration, arrangement, and/or association than illustrated in instrument trainer 100, 200.

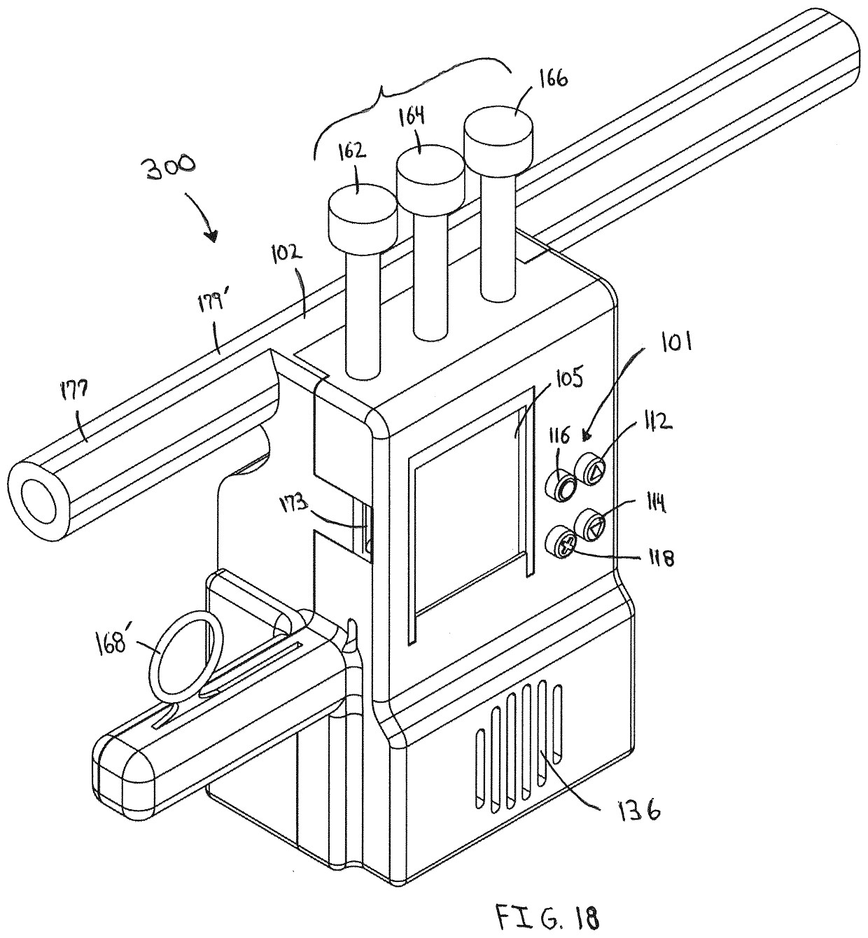

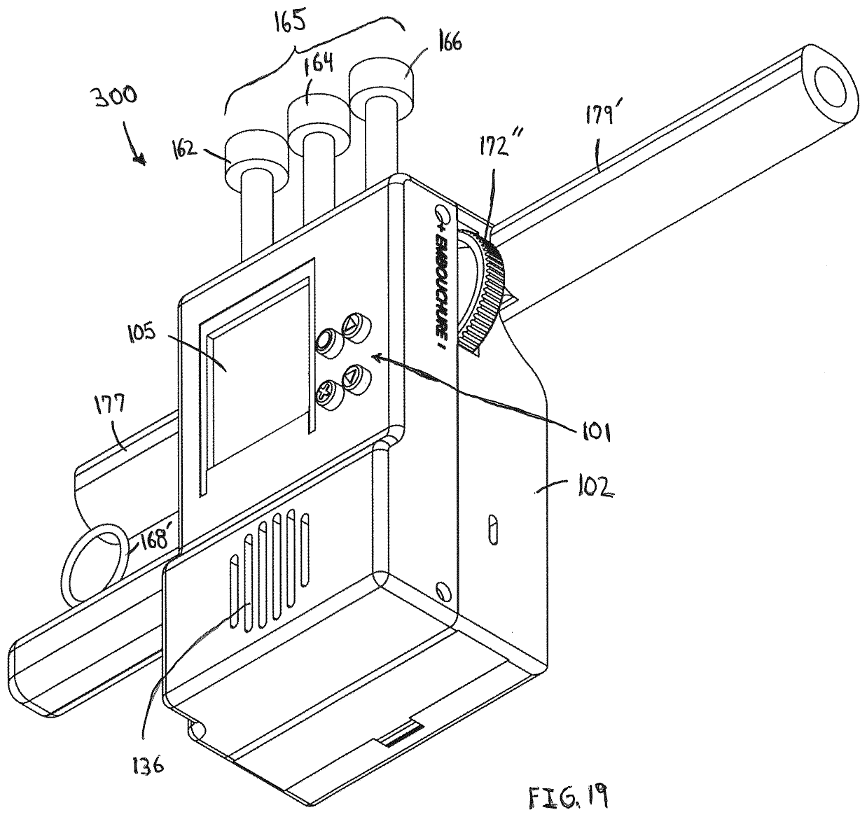

FIGS. 18-21 illustrate a brass (wind) musical instrument and trainer 300 (also referred to as “instrument”, “trainer” and/or “instrument/trainer”) according to a further embodiment. The instrument/trainer 300 includes a housing 102 having a display 105 and multiple input buttons 101 for configuring and operating instrument/trainer 300. The features and components of the embodiment of FIGS. 18-21 are similar to the embodiment of FIGS. 10-17, and the same numbers represent the same or a substantially similar feature. Description of features and components of the embodiment of FIGS. 18-21 that are the same or substantially the same as the embodiment of FIGS. 10-17 will not be repeated. Instead, the different features, functionality, components, and/or subsystems of instrument trainer 300 as compared to instrument trainer 200 will be the focus of the description of instrument/trainer 300.

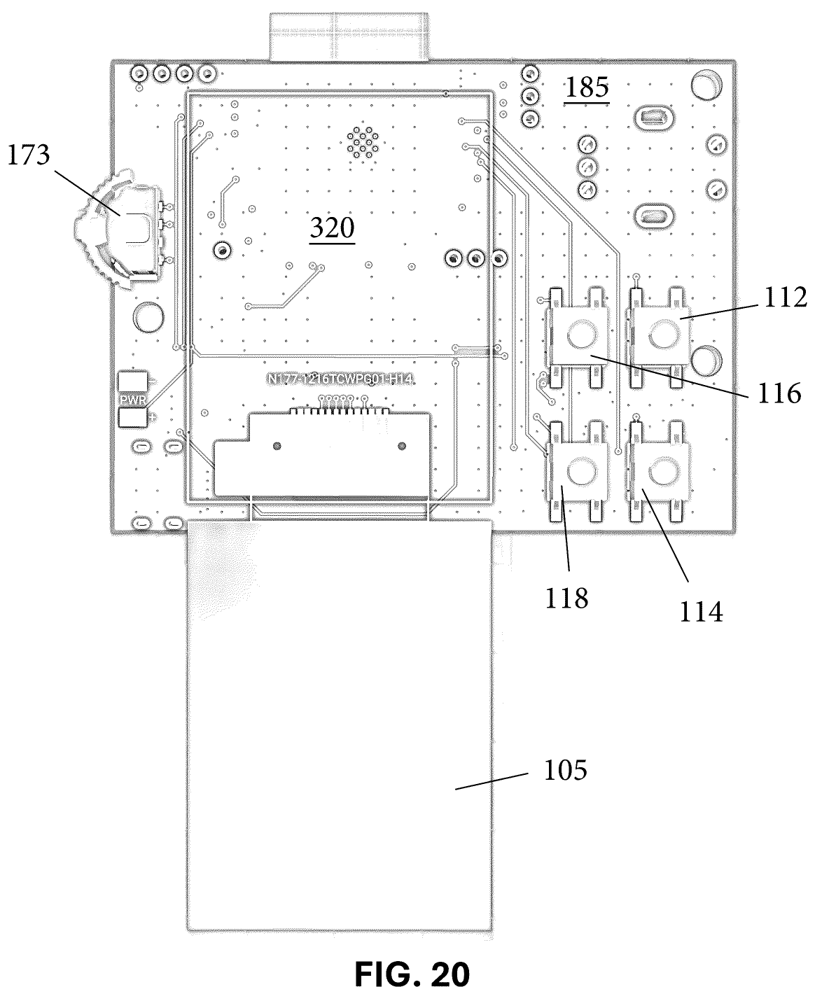

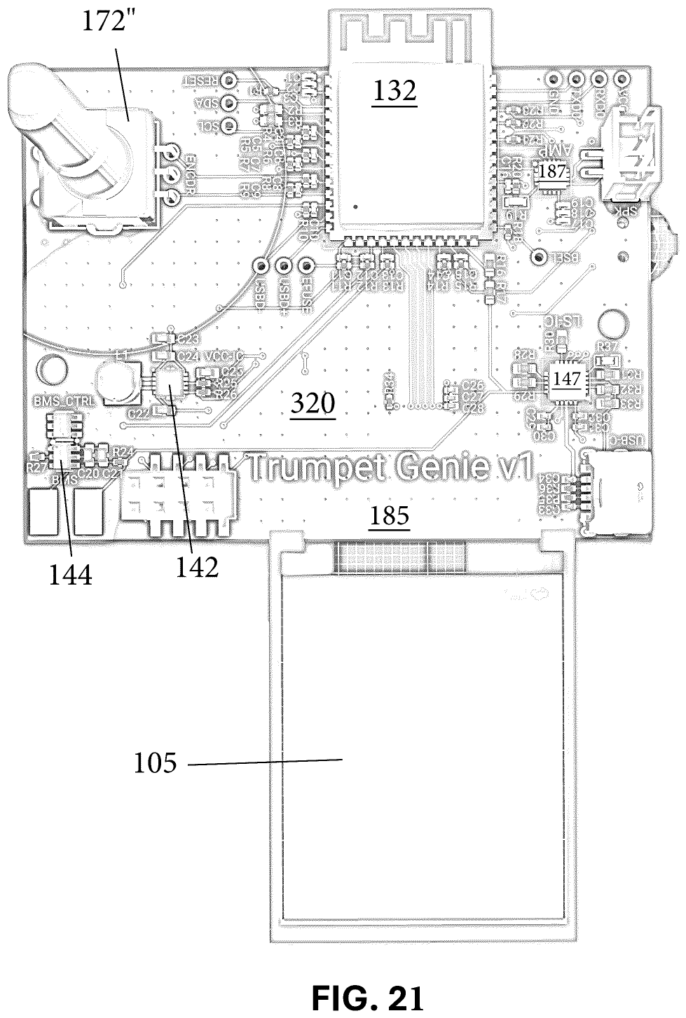

Within housing 102 of instrument/trainer 200 is circuitry 320 for generating and producing audio signals that can be converted into sound. FIGS. 20 and 21 illustrate a printed circuit board (PCB) 185 containing some of the circuitry 320 of instrument 300. Circuitry 320 operates substantially similar to circuitry 220 in instrument/trainer 200. Some of the main differences between circuitry 220 in instrument 200 and circuitry 320 in instrument 300 is the inclusion of three-position (rest control) switch 173, inclusion of rotary encoder 172″, and elimination of auto airflow switch 175. The differences between circuitry 220 and circuitry 320 will be discussed in more detail below.

In one or more configurations, the microcontroller unit (MCU) 132 in instrument 300 is preferably an ESP32 module, preferably mounted on a custom printed circuit board (PCB) 185, shown in FIGS. 20 and 21, that utilizes a Look-Up Table (LUT) (e.g., LUT Table 2) to select the audioData to generate based on fingerData and a variable input. The fingerData comprises input signals from a linear slider 168′ and/or multiple (e.g., three) upper key buttons 165. The variable input operator in instrument trainer 300 that provides the variable input comprises a rotary encoder 172″ that includes 36 physical detents, internally mapped to eight (8) discrete positions ranging from 0 to 7, where positions below the valid range are interpreted as 1 and those above as 7.

Instrument 300 in an embodiment uses a LUT similar to or the same as representative Table 2 showing the fingerData (using three keys 162, 164, 165 and slider ring 168′ of instrument/trainer 300), the embouchure level (by operation of the rotary encoder 172″) and/or the pressure as measured by a pressure sensor 176 from integrated mouthpiece assembly 179′ and the resulting and/or corresponding audioData. It can be appreciated that the LUT Table 2 does not show all the notes but only a sampling of the notes and resulting audioData.

Audio processing in example instrument 300 is performed by a MAX98357A module 187 that integrates digital-to-analog conversion and amplification of the audio signal produced by the microcontroller (MCU 132). That is, DAC 134 and AMP 135 are integrated into a single module 187, e.g., a MAX98357A module 187. Audio output is delivered via an integrated speaker 136. The PCB 185 includes many of the features and functions of circuitry 330, including the features and functions of main board 130 (including MCU 132), control panel board 150, keys board 160, and variable input board 170.

Instrument/trainer 300 in one or more configurations includes a configurable three-position rest control switch 173. The configurable three-position (rest control) switch 173 is assignable via the user interface, e.g., buttons 101, allowing any of its three positions; e.g., up, middle, or down, to function as a temporary silence toggle (REST), off (no REST) position, or a permanent silence toggle (HOLD). Activation of the rest control (button) switch 173 in the embodiment of instrument 300 does not suppress or alter fingerData; it only affects whether the instrument generates corresponding audioData.

Instrument 300 in one or more arrangements includes power management circuitry that has and/or includes a power switch 110, a battery pack 146 (e.g., a 18650 rechargeable Lithium-Ion Battery), a battery management system (BMS) 144, e.g. a DW01A battery management system for lithium-ion cell protection, a charging port (e.g., a USB-C charging port), and an MCP73871T integrated circuit (IC) for intelligent load balancing during charging and operation (e.g., power manager 147). A TPS63001 DC-DC converter facilitates voltage stability for the microcontroller and supporting components. In the example embodiment of instrument 300 no auxiliary audio jack is present, however, an auxiliary audio jack can be included to output the audio signal.

Instrument 300 in an arrangement includes four user-interface buttons 101; up button 112, down button 114, enter button 116, and cancel button 118, used for general navigation and control of the instrument 300. In one or more embodiments, instrument/trainer 300 includes a display module 105, preferably a N177-1216TCWPG01-H14, and includes the four operator control buttons 101; up button 112, down button 114, enter button 116, and cancel (return) button 118, for navigating the display interface and modifying the operation and/or behavior of instrument 300.

The display module 105 in one or more arrangements includes a status bar at the top showing a battery indicator and optionally a brand name. Upon powering the instrument 300, a user is presented with a main menu on the display module 105 containing the following options: PLAY; SETTINGS; HELP; and INFO. The user navigates the menu using the up and down buttons 112, 114, selects an option with the enter button 116, and returns to the previous screen using the cancel (return) button 118.

In instrument 300, when PLAY is selected, the display module screen presents a user interface for real-time interaction. In one or more embodiments, this user interface includes a graphical volume slider adjustable via the up and down buttons 112, 114, binary indicators labeled REST and HOLD showing the current status of rest (button) switch 173 (e.g., temporary silence, off (no REST), or permanent silence), a visual indicator of the current note derived from fingerData, and a circular visual slider that reflects the mapped position (0-7) of the rotary encoder 172′. More or less, including other, visual indicators can be displayed.

The SETTINGS screen presents configuration options for the three-position (rest) switch 173, allowing the user to individually assign each of its positions; up, middle, or down, to function as either REST (temporary silence toggle), OFF, or HOLD (permanent silence toggle). The HELP screen provides information about the instrument's settings and controls, including explanations of the rotary encoder 172′, and the meanings of REST and HOLD. The INFO screen displays a QR code and the corresponding website URL, directing users to the official product website for further information or support. Pressing the cancel button 118 returns the user to the main menu.

In one or more optional embodiments, the instrument 300 includes a mouthpiece assembly 179′ comprising a mouthpiece 177 and a pressure sensor 176. In this configuration, a user may blow into the mouthpiece to produce a variable pressure signal, which is read by the microcontroller 132. The signal is mapped to one of eight (8) discrete levels, consistent with the value range produced by the rotary encoder 172″. The user may select between the variable input modes (e.g., user-initiated air pressure by blowing into mouthpiece assembly 179′ or rotary encoder 172″) via the graphical interface, where a menu option allows switching between “Play with Knob” and “Play by Blowing”, or other such terminology to distinguish between the two modes. When the blowing mode is active, the rotary encoder 172″ is disabled, and when the rotary encoder mode is active, the mouthpiece assembly 179′ is disabled. It can be appreciated that an air flow switch 175, similar to the embodiment of FIGS. 10-17, can be included to select between the two modes of operation.

It can be appreciated that instrument 300 in one or more embodiments does not implement the mouthpiece assembly 179′, for example, no pressure sensor 177 is used and/or implemented. Alternatively, instrument 300 in one or more embodiments does not implement the rotary encoder 172″, for example no rotary dial and/or linear slider is included and/or implemented. In the configurations of instrument 300 where only one mode of variable input is implemented, no air flow switch 175 or menu interface to select between the two different variable input modes are necessary and such features may be removed.

In an additional optional embodiment, the instrument 300 may include wireless communication via Bluetooth. This functionality may enable the connection of external Bluetooth speakers for audio output, as well as other control and/or operating functions.

Alternate embodiments are possible that have features in addition to those described herein or may have less than all the features described. Functionality may also be, in whole or in part, distributed among multiple components, in manners now known or to become known. The discussion of any embodiment is meant only to be explanatory and is not intended to suggest that the scope of the disclosure, including the claims, is limited to these embodiments. In other words, while illustrative embodiments of the disclosure have been described in detail herein, it is to be understood that the inventive concepts may be otherwise variously embodied and employed, and that the appended claims are intended to be construed to include such variations, except as limited by the prior art.

Those skilled in the art will recognize that the disclosed and illustrated brass musical instrument and trainer will have many applications, may be implemented in various manners and, as such is not to be limited by the disclosed embodiments and examples, but it is intended to cover modifications within the spirit and scope of the invention. For example, use of the brass musical instrument and trainer as a trumpet, trombone, tuba, flute, or other wind, or another instrument is contemplated. While fundamental features of the invention have been shown and described in exemplary embodiments, it will be understood that omissions, substitutions, and changes in the form and details of the disclosed embodiments of the brass musical instrument and trainer may be made by those skilled in the art without departing from the spirit of the invention. Any number of the features of the different embodiments described herein may be combined into a single embodiment and/or the location, arrangement, and sizing of elements and/or components, for example, the keys (valves), pressure mouthpiece, rest switch, airflow toggle switch, and variable slider (e.g., rotary disc), may be altered and/or modified.

We claim:

1. An electrical audio generating apparatus to emulate audio sound produced by a represented instrument, the apparatus comprising:
a housing containing audio sound generating circuitry having a microcontroller unit,
multiple user-operated input key buttons extending from the housing to emulate valves of the represented instrument, the multiple input buttons moveable into multiple combinations of positions to provide fingerData input to the circuitry, and
a variable input operator extending from the housing to emulate a level of embouchure and airflow, the variable input operator controllable by a user to provide a variable input into the circuitry,
wherein the fingerData input and the variable input are received by the circuitry and processed by the microcontroller unit to produce audioData representing an audio sound corresponding to a note that is based upon the positioning of the multiple input key buttons and the variable input provided by the variable input operator.

2. The apparatus of claim 1, wherein the microcontroller selects the audioData using a look up table based upon the fingerData and the variable input.

3. The apparatus of claim 1, wherein the microcontroller is an ESP32 module.

4. The apparatus of claim 1 wherein the variable input operator is at least one of a variable input group consisting of; a rotary dial, a linear slider, and combinations thereof.

5. The apparatus of claim 1, wherein the variable input operator comprises a rotary encoder that has multiple selectable positions corresponding to multiple different input levels for the variable input.

6. The apparatus of claim 1, wherein the variable input group has eight (8) selectable positions.

7. The apparatus of claim 1, wherein the multiple user-operated input key buttons comprises four key buttons.

8. The apparatus of claim 1, wherein at least one of multiple user-operated input key buttons is a slidable ring valve.

9. The apparatus of claim 1, wherein the circuitry further comprises at least one of a coder/decoder group consisting of: an audio codec, an audio digital to analog converter (DAC), and combinations thereof to convert a digital signal produced by the microcontroller to an analog sound signal.

10. The apparatus of claim 9, wherein the circuitry further comprises an amplifier to adjust the magnitude of the analog sound signal produced by the coder/decoder group, and the DAC and amplifier are integrated into a single audio module.

11. The apparatus of claim 1 further comprising a speaker to convert the analog signal produced and output audio sound.

12. The apparatus of claim 1, further comprising a display and operator display control buttons for changing the display content and apparatus operation.

13. The apparatus of claim 1, further comprising a rest button extending from the housing and operable by a user to provide at least one of a silence group consisting of: no audio sound from the apparatus, no output from the microcontroller, no audioData produced by the microcontroller, or combinations thereof.

14. The apparatus of claim 13, wherein the rest button is user configured via a graphical interface and comprises a three position switch to toggle between at least temporary silence and permanent silence.

15. The apparatus of claim 1, wherein the variable input operator comprises a mouthpiece assembly having a mouthpiece for a user to blow into and a pressure sensor that produces a variable pressure signal corresponding to the variable pressure generated by the user blowing into the mouthpiece, the mouthpiece assembly sending the variable pressure signal to the microcontroller as the variable input used to produce the audioData by the microcontroller unit.

16. The apparatus of claim 15, wherein the mouthpiece assembly is integrated into a housing containing the multiple user-operated input key buttons.

17. The apparatus of claim 15, wherein at least one of a control group consisting of an airflow toggle switch, a display menu, and combinations thereof is used to select between the mouthpiece assembly or a manually operated multi-position switch to provide the variable input into the circuitry.

18. The apparatus of claim 1, further comprising a rechargeable battery pack, a battery management system, and a voltage regulator.

19. The apparatus of claim 1, further comprising at least one of a wireless connectivity group consisting of: Bluetooth, WiFi, and combinations thereof.

20. A method of generating audio sound signals the method comprising:
receiving by circuitry containing a microcontroller unit binary inputs from at least four moveable user operated key buttons and a variable input from a user operable variable input operator;
looking up in a look-up-table the four binary inputs and the variable input to determine an audioData representing audio sound corresponding to a note; and
producing the audio sound corresponding to the note.
